(19) United States
(12) Patent Application Publication
(10) Pub. No.: US 2026/0279053 A1
(43) Pub. Date: Sep. 17, 2026

(54) SYSTEM AND METHOD FOR PROCTORING OF EXAMINATIONS USING A 3D PROCTOR VIDEO GENERATED FROM MULTIPLE VIDEO FEEDS

(71) Applicants: Constructor Technology AG, Schaffhausen (CH); Constructor Education and Research Genossenschaft, Schaffhausen (CH)

(72) Inventors: Nwafor Chinedu KENNETH, Singapore (SG); Karsten KOZEMPEL, Nürnberg (DE); Rasilia RAKHMATULINA, Sofia (BG); Laurent DEDENIS, Geneve (CH); Stanislav PROTASOV, Singapore (SG); Serg BELL, Singapore (SG); Nikolay DOBROVOLSKIY, Alanya (TR)

(21) Appl. No.: 19/075,850

(22) Filed: Mar. 11, 2025

(51) Int. Cl. G06V 20/40; G06V 10/774; G06V 10/776; G06V 10/82; G06V 20/52; G06V 40/20; G09B 7/00

(52) U.S. Cl. CPC G06V 20/44; G06V 10/774; G06V 10/776; G06V 10/82; G06V 20/52; G06V 40/20; G09B 7/00

(57) ABSTRACT

Disclosed herein are systems and methods for generating a three-dimensional (3D) proctor video of a user taking an examination. In one aspect, an exemplary method includes obtaining a first and a second multi-view video feed of the user taking the examination. The method also includes generating a 3D video of the user by inputting the first and the second multi-view video feed into a 3D reconstruction engine. The method also includes identifying objects that the user interacts with while taking the examination and detecting events in the 3D video. The method further includes generating a list of identified objects in the 3D video and a list of detected events in the 3D video based on the detected events in the 3D video. The list of detected events comprises at least events determined as suspicious cheating activity and events determined as normal test taking activity.

### FIELD OF TECHNOLOGY

The present disclosure relates to the field of machine learning, and, more specifically, to systems and methods for machine-learning based methods for proctoring examinations.

### BACKGROUND

Examinations are now commonly taken on computers, offering convenience and accessibility for both learners and institutions. These computer examinations are conducted through specialized software or platforms that allow learners to take tests from remote locations. They often include features like automated proctoring, time tracking, and instant grading. However, this shift to computer examinations has also introduced new opportunities for cheating. Learners might use unauthorized resources such as notes, search engines, or communication tools like messaging apps during the exam. Other learners may simply have someone else pretend to be the learner and take the computer examination for the learner under the learner's login credentials. In other cases, in examinations with video proctoring, a pre-recorded video loop of the candidate sitting still or pretending to take the exam could be played while the real exam is being taken by someone else. These methods exploit the weaknesses in online proctoring systems, especially in cases where human proctors or artificial intelligence (AI) may not be able to detect subtle signs of cheating. To counteract these tactics, some examination platforms are increasingly using sophisticated AI proctoring techniques.

### SUMMARY

To address the shortcoming of proctoring examinations, the present disclosure describes training machine learning models (MLMs) to generate a 3D video of a user (e.g., exam taker) based on multiple camera feeds to identify objects that the user interacts with when taking an examination. Specifically, the present disclosure describes generating a 3D video of the user based on using at least two video feeds of the user and identifying objects that the user interacts with while taking the examination within the 3D generated video to detect events involving the object that may constitute suspicious cheating activity.

Generating a 3D video of a user taking an examination for proctoring offers significant technical benefits that enhance the capabilities of monitoring systems. For example, a 3D video allows for multi-angle viewing, capturing a comprehensive representation of the user's environment and interactions, which significantly reduces blind spots compared to traditional 2D video. The spatial data provided by 3D modeling facilitates advanced motion tracking, enabling precise analysis of head movements, eye direction, and hand gestures. This spatial awareness also allows for the accurate detection of unauthorized devices or materials, as the system can measure distances and relationships within the user's environment. Additionally, 3D video data is highly compatible with AI algorithms, enabling more robust and accurate behavior analysis, as it provides richer datasets for machine learning models.

This technology also allows for dynamic post-exam reviews, where specific moments can be revisited and analyzed from various angles, enhancing the efficiency, accuracy, and reliability of manual or automated review processes. Furthermore, the 3D video's detailed environmental context improves the accuracy of noise reduction and anomaly detection systems, minimizing false positives. By integrating these advanced technical features, 3D video technology significantly enhances the scalability, precision, and reliability of online proctoring systems. By identifying objects and detecting events in a 3D generated video, examination systems can provide a more secure, fair, and efficient testing environment while gathering valuable insights to improve the overall exam-taking experience.

In one exemplary aspect, a method for generating a 3D proctor video of a user taking an examination is disclosed, the method comprises: obtaining, from a first camera and a second camera pointed at the user, a first and a second video feed of the user taking the examination, respectively; generating a 3D video of the user by inputting the first and the second video feed into a 3D reconstruction engine; identifying objects that the user interacts with while taking the examination by using a prepared 3D object detection machine learning model (MLM); detecting events in the 3D video based on the identified objects; and generating a list of identified objects in the 3D video based on an output of the prepared 3D object detection MLM and a list of detected events in the 3D video based on the detected events in the 3D video, wherein the list of detected events comprises at least events determined as suspicious cheating activity and events determined as normal test taking activity.

In some aspects, the techniques described herein relate to a method, wherein the list of events to detect further comprises at least events determined as normal test taking activity.

In some aspects, the techniques described herein relate to a method, further comprising: performing a validation on the identified objects and detected events in the 3D video by utilizing a trained 2D detection model trained with 2D images by identifying objects in a first 2D video feed and detecting events in a second 2D video feed; and discarding identified objects or detected events that do not pass the validation from the generated list

In some aspects, the techniques described herein relate to a method, further comprising: training a 3D event detection ML model to detect events in the 3D video using a training 3D events dataset comprising a sequence of frames containing an object or an action performed by the user and an event label identifying the action in the sequence of frames of a video; and detecting events in the 3D video by using the trained 3D event detection ML model.

In some aspects, the techniques described herein relate to a method, further comprising: detecting the 3D video events analytically.

In some aspects, the techniques described herein relate to a method, further comprising: performing a validation on the identified objects and detected events in the 3D video by utilizing a trained 2D detection model trained with images obtained from a stitching of the video feed from the first camera and the video feed of the second camera; and discarding identified objects or detected events that do not pass the validation from the generated list.

In some aspects, the techniques described herein relate to a method, further comprising: training the 2D detection model to detect objects in 2D images using a 2D object dataset comprising images of objects and an object label identifying each object in the images to visually detect and distinguish between different objects.

In some aspects, the techniques described herein relate to a method, further comprising: predicting cheating behavior of the user based on inputting the generated list of events or objects detected in the 3D video into a trained behavior prediction model to recognize specific behavior events in the 3D video by at least tracking the user, the identified objects, and the detected events in a sequence of frames of the 3D video.

In some aspects, the techniques described herein relate to a method, wherein the trained behavior prediction model corresponds to sequential model such as recurrent neural networks (RNN) (e.g., Gated Recurrent Unit (GRU) and Long Short-Term Memory (LSTM)) or a Transformer model.

In some aspects, the techniques described herein relate to a method, further comprising: displaying, on a computer of the user, a warning in real-time based on the outputs of the trained behavior prediction model.

In some aspects, the techniques described herein relate to a method, further comprising: training the behavior prediction model to predict cheating behavior of the user by using a prediction training set comprising of a sequence of frames containing an object or an action performed by a person with an object and an event label identifying the action in the sequence of frames of the video as suspicious behavior or normal test taking behavior to visually detect and distinguish between the suspicious behavior and normal test taking behavior.

In some aspects, the techniques described herein relate to a method, further comprising: generating a virtual-reality (VR) feed for use on a VR-compatible headset using a VR conversion engine.

In some aspects, the techniques described herein relate to a method, wherein the multi-view video feed comprises at least a frontal view feed and a side view feed of the user.

In some aspects, the techniques described herein relate to a method, wherein the list of events to detect further comprises a list of cheating events, a list of allowed events corresponding to normal test taking behavior, and a list of prohibited test taking behavior.

According to one aspect of the disclosure, a system is provided for generating a 3D proctor video of a user taking an examination, the system comprising at least one memory; and at least one hardware processor coupled with the at least one memory and configured, individually or in combination to: obtain, from a first camera and a second camera pointed at the user, a first and a second video feed of the user taking the examination, respectively; generate a 3D video of the user by inputting the first and the second video feed into a 3D reconstruction engine; identify objects that the user interacts with while taking the examination by using a prepared 3D object detection machine learning model (MLM); detect events in the 3D video based on the identified object; and generate a list of identified objects in the 3D video based on an output of the prepared 3D object detection MLM and a list of detected events in the 3D video based on the detected events in the 3D video, wherein the list of detected events comprises at least events determined as suspicious cheating activity and events determined as normal test taking activity.

In one exemplary aspect, a non-transitory computer-readable medium is provided storing a set of instructions thereon for generating a 3D proctor video of a user taking an examination, wherein the set of instructions comprises instructions for: obtaining, from a first camera and a second camera pointed at the user, a first and a second video feed of the user taking the examination, respectively; generating a 3D video of the user by inputting the first and the second video feed into a 3D reconstruction engine; identifying objects that the user interacts with while taking the examination by using a prepared 3D object detection machine learning model (MLM); detecting events in the 3D video based on the identified objects; and generating a list of identified objects in the 3D video based on an output of the prepared 3D object detection MLM and a list of detected events in the 3D video based on the detected events in the 3D video, wherein the list of detected events comprises at least events determined as suspicious cheating activity and events determined as normal test taking activity.

The above simplified summary of example aspects serves to provide a basic understanding of the present disclosure. This summary is not an extensive overview of all contemplated aspects and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for generating a three-dimensional (3D) proctor video of a user taking an examination for detecting suspicious cheating behavior according to aspects of the present disclosure.

FIG. 2 is a block diagram illustrating a system for training machine learning models (MLMs) to identify objects, detect events, and/or predicting cheating behavior in a 3D video of a user taking an examination according to aspects of the present disclosure.

FIG. 3 is a block diagram illustrating an example system of multiple camera setups configured to generate a 3D video according to aspects of the present disclosure.

FIG. 4 is a block diagram of an example of a pipeline for reconstructing a 3D video from multiple video feeds to detect suspicious behavior of a user taking an examination according to an aspect of the present disclosure.

FIG. 5 is an example method for generating a 3D proctor video of a user taking an examination according to aspects of the present disclosure.

FIG. 6 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for a machine-learning (ML)-based method for proctoring examinations based on a generated three-dimensional (3D) video of a user taking a test. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure describes various aspects of generating a 3D proctor video of a user taking an examination. One aspect involves obtaining a first and second video feed of the user from a first and a second camera to generate a 3D video of the user taking an examination. A second aspect involves identifying objects that the user interacts with while taking the examination using a trained 3D object detection machine learning model (MLM). A third aspect involves detecting events in the 3D video based on the identified objects in the 3D video. A fourth aspect involves predicting suspicious cheating behavior of the user based on the detected events in the 3D video.

Generating a 3D video of a user taking an examination for proctoring is essential to address the limitations of traditional proctor monitoring methods and ensure the integrity of the examination process. Unlike a two-dimensional (2D) video, which captures limited perspectives and can leave blind spots, a 3D video provides a comprehensive, multi-angle view of the user and their surroundings. This allows proctors to accurately observe behaviors of the user such as eye movements, head tilts, and hand gestures, which are critical for detecting suspicious behavior.

In addition, a 3D video captures the spatial relationships within the test-taker's environment and interaction with objects, enabling precise detection of objects such as unauthorized devices or materials that might otherwise go unnoticed. This level of detail is particularly important for exams where ensuring fairness is paramount. The enriched data provided by 3D videos also enhances the capabilities of AI-driven proctoring systems, enabling more accurate flagging of suspicious activities and reducing false positives. Moreover, in cases of disputes or challenges, 3D recordings offer stronger evidence by allowing examiners to revisit and analyze specific moments from different perspectives and angles. By combining these advantages, 3D video technology ensures a higher level of security, fairness, and reliability, making it a crucial tool for modern online proctoring systems.

The present disclosure describes generating a 3D video of a user taking an examination based on multiple camera feeds. The present disclosure also describes using advanced MLMs to at least identify objects that a user interacts with while taking the examination in the 3D generated videos. The present disclosure also describes using MLMs to detect events (e.g., suspicious cheating behavior or normal test taking behavior) based on identifying particular objects in certain sequences in the 3D video, perform validation on the identified objects and detected events, and predict cheating behavior of the user.

Using MLMs to detect suspicious cheating behavior in a 3D video of a user taking an examination is highly useful for several key reasons, particularly in ensuring the integrity and fairness of online assessments. Online exams, especially in remote learning environments, face challenges related to cheating, as students have access to various resources and distractions that may lead to dishonest behavior. By leveraging machine learning to analyze 3D video footage of exam takers, educational institutions can automatically and accurately detect suspicious actions that may indicate cheating.

First, 3D video provides a more comprehensive view of the user's environment and actions compared to 2D video. Machine learning models can monitor not just the student's face and body movements but also their surroundings and interactions with objects, enabling the detection of behaviors like looking away from the screen (potentially signaling that the user is consulting unauthorized materials or other people) or unusual hand movements (which may indicate the use of hidden devices). The ability to track depth and spatial positioning in a 3D environment allows the model to distinguish between normal body movements such as checking a clock, looking up to think, etc. and behaviors that may suggest cheating, such as excessive movement of the eyes, rapid head turns, or actions indicating the use of external help, like referencing a phone or another monitor.

Additionally, the MLM can detect abnormal behavior patterns, such as a user's interaction with different objects, which might indicate that they are using unauthorized tools, interacting with someone off-screen, or engaging in other forms of cheating. The model's capacity to continuously track the candidate in a 3D space allows it to identify irregularities that would be difficult for a human proctor to catch in real-time, especially in remote or large-scale online exam settings.

Furthermore, real-time analysis with machine learning allows for immediate intervention when suspicious behavior is detected. This can prevent further cheating or provide a timely alert to proctors for further investigation. By automating this process, institutions can ensure a higher level of exam security and integrity without overburdening proctors or creating privacy concerns, as the detection can be done through analysis of the 3D video rather than relying on intrusive monitoring techniques.

Finally, MLMs can be trained to recognize specific cheating patterns by analyzing large datasets of events from previous exams, improving their accuracy over time. They can be fine-tuned to detect subtle, context-specific actions, such as glancing toward a hidden device or making rapid hand movements that suggest accessing a cheat sheet. This level of precision and scalability makes it an invaluable tool for maintaining fairness in online testing environments.

Turning now to the figures, example aspects are depicted with reference to one or more components described herein, where components in dashed lines may be optional.

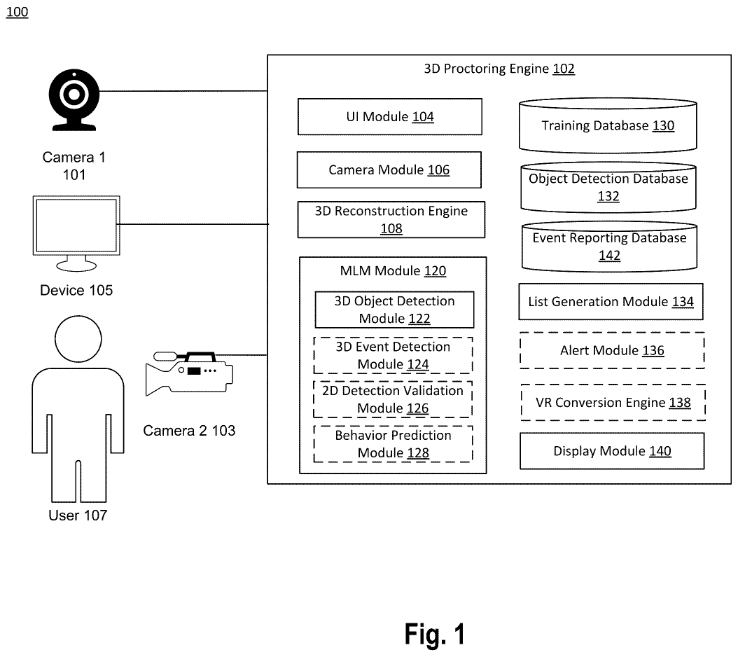

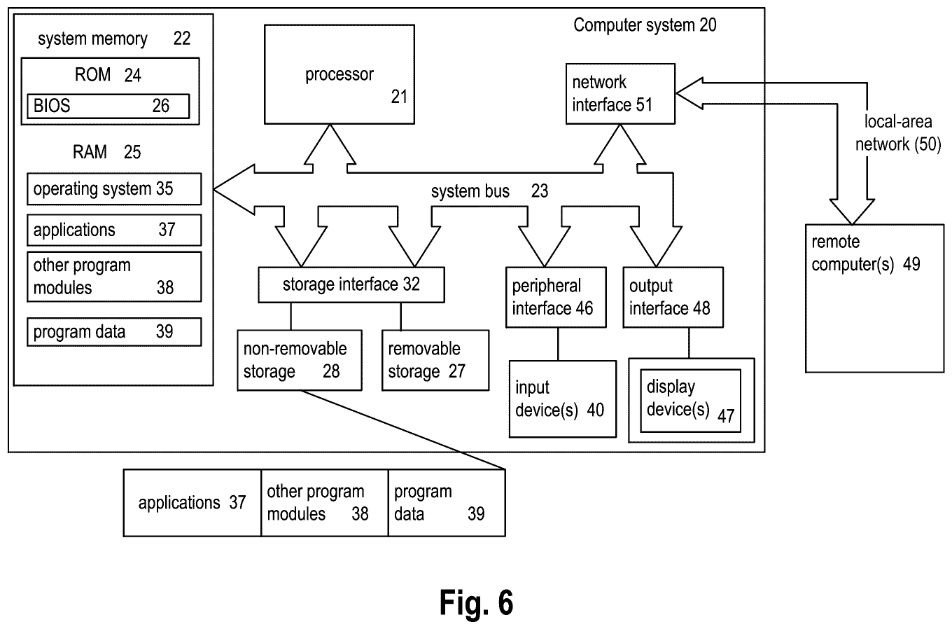

FIG. 1 is a block diagram illustrating a system 100 configured to generate a 3D proctor video of a user taking an examination for detecting suspicious cheating behavior. In one aspect, the components of system 100 may be implemented on computer systems, such as that shown in FIG. 6.

The system 100 may be used to implement a real-time monitoring system that generates a 3D video feed for detecting cheating behavior by a user. In one aspect, the system 100 includes at least a user 107 taking an examination on a device 105 or simply taking an examination (e.g., the user does not have to use the device 105 to take the examination), at least a first camera 101 and a second camera 103, and a 3D proctoring engine 102. The 3D proctoring engine 102 will be configured to monitor a user 107 taking an examination using a 3D video generated based on video feeds from at least the first camera 101 and the second camera 103. In some aspects, the first camera 101 may be capturing the user 107 from a front view and a second camera 103 may be capturing the user 107 from a side view. As an example, the 3D proctoring engine 102 may be hosted on a cloud server or allocated at a local device (e.g., such as the device 105).

In some aspects, the first camera 101 may be coupled to the device 105 as a webcam. In some aspects, the first camera 101 may communicate directly with the 3D proctoring engine 102 and be mounted in a room or the device 105 to capture the test taking environment. In some aspects, the second camera 103 may also be coupled to the device 105 to as separate camera capturing another angle of the user 107. In some aspects, the second camera 103 may communicate directly with the 3D proctoring engine 102 and be mounted in a room to capture the test taking environment.

In some aspects, the 3D proctoring engine 102 may contain at least a UI module 104, a camera module 106, a 3D reconstruction engine 108, a MLM module 120 including at least a 3D object detection module 122, an optional 3D event detection module 124, an optional 2D detection validation module 126, and an optional behavior prediction module 128, a list generation module 134, an optional alert module 136, an optional virtual-reality (VR) conversion engine 138, and a display module 140. The 3D proctoring engine 102 may be connected to at least a training database 130, an object detection database 132, and/or an event reporting database 142. In some aspects, these databases may also be hosted on the device 105 or a local machine. In some aspects, these databases may be hosted on a cloud server. In some aspects, the 3D proctoring engine 102 may generate a user interface (UI) for display, which may be part of a client application associated with the 3D proctoring engine 102.

The 3D proctoring engine 102 may execute a UI module 104 to implement a UI for display on the device 105 that is configured to receive input from the device 105, administer the examination to the user 107. In some aspects, the UI module 104 generates a single UI and layout and components of the UI elements (e.g., menus, buttons, forms, grids, etc.) based on predefined rules, data models, or templates. In some aspects, the UI module 104 may also be configured to automatically adjust the UI elements based on the content or data that it needs to display such as adapting a form to input fields or displaying a list of items. In some aspects, the UI module 104 may also be configured to adapt the UI to different screen sizes and resolutions by making sure that the UI works well across various devices.

The 3D proctoring engine 102 may execute a camera module 106 configured to calibrate, detect, and monitor the user 107 taking an examination on the device 105 using at least the first camera 101 and the second camera 103. The camera module 106 captures visual data in the form of images or video clips, which is then processed by the 3D proctoring engine 102 to generate a 3D video of the user 107. In particular, the camera module 106 may be configured to obtain, using the first camera 101 pointed at the user 107 and a second camera 103 pointed at the user 107, at least one video stream of the user 107 sitting in front of the device 105. Advanced algorithms (e.g., computer vision, machine learning) are used to detect the presence of people by recognizing shapes, movement, or patterns that signify human activity. This module serves as the interface layer that facilitates communication between the first camera 101 and the second camera 103 and the 3D proctoring engine 102.

The 3D proctoring engine 102 may execute a 3D reconstruction engine 108 configured to generate a 3D video by inputting a video feed from the first camera 101 and a second video feed from the second camera 103 or from 2D images. Different algorithms or MLMs may be used to implement the 3D reconstruction engine 108. As an example, the 3D reconstruction engine 108 may correspond to a MultiView Stereo (MVS) algorithm using OpenMVS and Open Multiple View Geometry (OpenMVG) to recover the initial camera configuration from the video feeds. MVG is dedicated to recovering camera locations and orientations from data such as images and camera intrinsics by yielding a sparse set of 3D points through triangulation based on feature points observed in the photographs. MVS focuses on generating a dense 3D reconstruction of the object. This may take the form of a dense point cloud, a faceted surface (mesh), or a set of planes such that the results can be visualized as a realistic 3D rendering of the scene.

As a non-limiting example, reconstructing a 3D model from 2D images using OpenMVG and OpenMVS involves several key steps. First, multiple high-quality, overlapping images of the object or scene from different angles are captured. Next, information and metadata from these images including EXIF metadata, which contains critical details such as the image's dimensions, camera information, exposure time, and focal length are captured. Distinctive features in each image are detected and extracted using algorithms like SIFT (Scale-Invariant Feature Transform), AKAZE (Accelerated-KAZE), or SURF (Speeded-Up Robust Features). Once features are extracted, corresponding features across images are matched to establish relationships, employing techniques such as Exhaustive Matching or Nearest-Neighbor Search.

Using the matched features, Structure from Motion (SfM) is applied to estimate the relative positions and orientations of the cameras and generate a sparse 3D point cloud representing the scene. This sparse point cloud is then enhanced by estimating depth information to create a denser representation of the scene, which involves computing depth maps for all images and merging them into a 3D mesh. The dense point cloud is converted into a mesh that defines the 3D geometry using vertices, edges, and faces.

Further steps include refining the mesh to smooth surfaces, reduce noise, and correct inaccuracies for better precision. The final step is applying textures to the refined mesh using the original images, which creates a realistic and visually detailed 3D model. By following these steps with OpenMVG and OpenMVS, a detailed 3D model may be effectively modeled from 2D images.

In some aspects, the MLM module 120 may contain prepared MLMs for executing specific tasks. There are several possible approaches that may be implemented using computer vision and machine learning models such as a neural network (e.g., a convolutional neural network (CNN) and/or a recurrent neural network (RNN)). A neural network is a type of machine learning process that uses interconnected nodes or neurons in a layered structure that resembles the human brain. The neural networks create an adaptive system that computers use to learn from their mistakes and improve continuously by comprehending unstructured data and making observations without explicit training. With neural networks, computers may distinguish and recognize images and/or events similar to humans. However, the neural networks in the 3D object detection module 122, the optional 3D event detection module 124, the optional 2D detection validation module 126, and the optional behavior prediction module 128 must first go through training to teach the neural network to perform their respective specific tasks.

The MLM module 120 may comprise one or more neural networks. The neural network executed by MLM module 120 may be one of the following: transformer neural network, convolution neural network (CNN), recurrent neural network (RNN), gated recurrent unit (GRU) network, long short-term memory (LSTM) network, autoencoder, generative adversarial networks (GAN). CNNs are effective for image-related tasks because CNNs may automatically learn spatial hierarchies of features from the input images. For videos, RNNs or LSTM networks can be used to capture temporal dependencies between frames. In some aspects, a hybrid model may be used by combining CNNs for spatial feature extraction and RNNs for temporal analysis.

A transformer is a deep learning architecture used in large language models (LLMs). The transformer has an encoder/decoder structure with numerous stacked multi-head attention layers and feed forward network layers. This architecture allows the model to process and generate text effectively, capturing long-range dependencies and contextual information. Transformers are well-suited for tasks like natural language processing, image classification and generation. Common examples of transformer models are generative pre-trained transformer (GPT) and Bidirectional Encoder Representations from Transformers (BERT).

A CNN is specialized for processing grid-like data, such as images, and employs convolutional layers to learn spatial hierarchies of features, reducing the need for manual feature engineering. CNNs are well-suited for tasks like image classification, object detection, and image generation.

An autoencoder is a type of neural network used for unsupervised learning and dimensionality reduction and consists of an encoder that compresses input data into a lower-dimensional representation (encoding) and a decoder that reconstructs the original input from the encoding.

A GAN comprises a generator and a discriminator trained simultaneously through adversarial training. The generator aims to generate realistic data, while the discriminator tries to distinguish between real and generated data. A GAN is widely used for image and content generation tasks.

For image recognition tasks, such as identifying objects that a user interacts with while taking the examination or detecting events based on the identified objects in the generated 3D video, an untrained neural network in the 3D object detection module 122, the optional 3D event detection module 124, and the optional 2D detection validation module 126 will first analyze the images from their respective training datasets (e.g., training database 130) to identify objects in the videos and detect events of a user taking an examination on the device 105 based on the identified objects. As an example, for object identification, the training dataset may include labeled dataset containing images of objects and object label identifying each object in the image. As another example, for event detection, the training dataset may include labeled dataset comprising a sequence of frames containing an object or an action performed by the user and an event label identifying the action in the sequence of frames of the video.

During training of the 3D object detection module 122 and the optional 2D detection validation module 126, the training dataset will include images of objects that are input through an untrained MLM in the 3D object detection module 122 and/or the optional 2D detection validation module 126. The results from the untrained neural network are then compared with known data set results (e.g., 3D object training dataset 203 or 2D object training dataset 207) using the corresponding object labels identifying each object in the image to visually detect and distinguish between different objects. It should be noted that the input to the 3D object detection module 122 and/or the optional 2D detection validation module 126 will be the images from the training dataset.

During training of the 3D event detection validation module 126, the training dataset will include a sequence of frames containing objects or actions performed by a user involving an object and an event label identifying the action in the sequence of frames of a video. The results from the untrained neural network are then compared with known data set results (e.g., known sequences making up events involving the object) using the corresponding action labels identifying an action (e.g., event label) in the sequence of frames of a video to visually detect and distinguish between events. It should be noted that the input to the optional 3D event detection module 124 will be a sequence of frames/objects from the training dataset.

For every input training sample from the training dataset, the neural networks from the 3D object detection module 122, the optional 3D event detection module 124, the optional 2D detection validation module 126 will produce a prediction consisting of values representing the probability that an object is detected in the image, or an event is detected in the sequence of frames. The output with the highest probability determines the predicted object label or event label. A class label for each input image is used to compute a loss (e.g., loss function).

The 3D object detection module 122, the optional 3D event detection module 124, and/or the optional 2D detection validation module 126 then uses a loss function that quantifies the error between the predicted output and the ground truth for a given training sample. In other words, the loss function can be used to guide the learning process by updating the network weights in a way that improves the accuracy of future predictions. This process may continue until the difference between the predictions and the correct targets is minimal. In some examples, an appropriate loss function, such as Mean Squared Error (MSE) for regression tasks (e.g., predicting brightness levels) or a Cross-Entropy Loss for classification tasks (e.g., detecting specific color changes).

In some aspects, an optimizer such as Adam or stochastic gradient descent (SGD) may be used to train the models in the 3D object detection module 122, the optional 3D event detection module 124, and/or the optional 2D detection validation module 126. In some aspects, the data may be split into training, validation, and test sets. In these aspects, the models from the 3D object detection module 122, the optional 3D event detection module 124, and/or the optional 2D detection validation module 126 are trained on the training dataset and then validated by the validation sets in order to tune hyperparameters.

Once the neural networks are trained (e.g., inference), the 3D object detection module 122, the optional 3D event detection module 124, and/or the optional 2D detection validation module 126 may detect objects and corresponding events in the generated 3D video. Specifically, the 3D object detection module 122, the optional 3D event detection module 124, and/or the optional 2D detection validation module 126 contains a prepared neural network configured to identify and detect objects captured in the generated 3D video of the user 107 taking the examination on the device 105, a prepared neural network configured to identify an object or an action in a sequence of frames of a video, and a prepared neural network configured to validate the identified objects and/or detected events in the 3D video by stitching video feeds of at least the first camera 101 and the second camera 103, respectively.

During inference, the trained neural networks from the 3D object detection module 122, the optional 3D event detection module 124, and/or the optional 2D detection validation module 126 do not re-evaluate or adjust the layers of the neural networks based on the results. Instead, the inference applies knowledge from the trained neural networks and uses it to infer a result (e.g., what object is identified in the 3D video, what event is detected in the 3D video, and/or validation of the identified objects and detected events). Accordingly, when a new unknown dataset (e.g., video stream) is input through the trained neural networks in the 3D object detection module 122, the optional 3D event detection module 124, and/or the optional 2D detection validation module 126, the trained neural networks outputs a prediction of what object is detected based on predictive accuracy of the neural networks.

The optional behavior prediction module 128 contains a prepared neural network configured to visually detect and distinguish between cheating behavior, normal test taking behavior, and suspicious behavior based on the detected events involving the identified object. Cheating behavior during an examination involves clear violations of rules, such as using unauthorized materials (e.g., notes, phones, or smartwatches), communicating with other test-takers, impersonating another person, pre-sharing answers, or using prohibited tools like calculators. By contrast, normal test taking behavior aligns with exam guidelines and includes actions like following instructions, asking proctors or test administrators for clarification or assistance, maintaining focus on one's work, and complying with the rules about approved materials and devices. Suspicious behavior, while not definitive proof of cheating, may warrant monitoring and includes frequent glancing at others'papers, unusual hand movements, excessive adjustments in posture, repeated requests to leave the room, or subtle attempts at communication with others. While cheating involves deliberate intent, suspicious behavior could also stem from anxiety or restlessness, making it essential for invigilators to carefully assess the context and patterns of such actions.

Similar to training the 3D object detection module 122, the optional 3D event detection module 124, and the optional 2D detection validation module 126, the untrained neural network in the optional behavior prediction module 128 will analyze the images from the training dataset and learn to identify events in sequences of frames of the video by detecting and learning what events are considered potential or suspicious cheating behavior and what events are normal test taking behavior. As an example, the training dataset may include labeled training data consisting of a sequence of frames containing an object or an action performed by the user 107 with an object and its corresponding ground truth (e.g., cheating behavior, suspicious behavior, or normal test taking behavior) labels. Accordingly, since the optional behavior prediction module 128 is designed to classify events as cheating behavior, suspicious behavior, or normal test taking behavior then the training dataset will need samples of different events.

The optional behavior prediction module 128 is trained by inputting a prediction training dataset comprising of a sequence of frames containing an object or an action performed by a person with an object and an event label identifying the action in the sequence of frames of the video as cheating behavior, suspicious behavior, or normal test taking behavior. During training of the neural network, the prediction training dataset is put through the untrained neural network from the optional behavior prediction module 128 and the results from the untrained neural network are then compared with known data set results (e.g., prediction training set) using the labels (cheating behavior, suspicious behavior, or normal test taking behavior).

For every input training sample, the optional behavior prediction module 128 will produce a prediction consisting of values representing the probability that the input image corresponds to a given class (e.g., cheating behavior, suspicious behavior, or normal test taking behavior). As an example, the optional behavior prediction module 128 produces a prediction in the form of probability values representing the likelihood that the input image corresponds to one of three classes: cheating behavior, suspicious behavior, or normal test-taking behavior. Each probability may range from 0 to 1, with the sum of probabilities across the three classes equaling 1. Clear cases might include a high probability for one class, such as 0.95 for cheating behavior and negligible values for the others, while ambiguous cases could involve more evenly distributed probabilities, such as 0.30 for cheating, 0.50 for suspicious, and 0.20 for normal behavior. In some implementations, the system 100 might use threshold-based classification, flagging behaviors as cheating or suspicious only if their probability exceeds a certain value, such as 0.8. Alternatively, binary or exclusionary classifications may assign a probability of 1 to one class and 0 to the others. This approach allows the system 100 to handle clear classifications while also supporting manual review for ambiguous cases where the probabilities are closely distributed across classes. The output with the highest probability determines the predicted prediction label. A class label for each input sequence of frames is then used to compute a loss (e.g., loss function).

The neural network in the optional behavior prediction module 128 then uses a loss function that quantifies the error between the predicted output and the ground truth (e.g., cheating behavior, suspicious behavior, or normal test taking behavior) for a given training sample. In other words, the loss function can be used to guide the learning process by updating the network weights in a way that improves the accuracy of future predictions.

The optional behavior prediction module 128 contains a prepared neural network configured to predict cheating behavior of the user. The prepared neural network in the optional behavior prediction module 128 may use visual cues and appearances of the identified object and/or people and their interaction with the object in images such as a person looking at a mobile phone, or a person looking at his watch for checking time, or the like to determine the event and identify the event as cheating behavior, suspicious behavior, or normal test taking behavior.

In some aspects, the prepared neural network in the optional behavior prediction module 128 is trained to predict cheating behavior of the user 107 based on inputting a generated list of events or objects detected in the 3D video into a trained recurrent network to recognize specific behavior events in the 3D video by at least tracking the user, the identified objects, and the detected events based on identifying the objects in a sequence of frames of the 3D video.

During inference (e.g., when the model makes predictions or evaluations based on the learned knowledge), the optional behavior prediction module 128 has a trained neural network that does not re-evaluate or adjust the layers of the neural network based on the results. Instead, the inference applies knowledge from the trained neural network model and uses it to infer a result (e.g., what is the event and is the event a cheating behavior, suspicious behavior, or normal test taking behavior). Accordingly, when a new unknown data set (e.g., video feeds or a 3D generated video) is input through a trained neural network in the optional behavior prediction module 128, the prepared neural network in the optional behavior prediction module 128 outputs a prediction of what event is detected in the sequence of frames and whether the detected event is a cheating behavior, suspicious behavior, or normal test taking behavior based on predictive accuracy of the neural network.

It should be noted that the prepared MLMs in the MLM modules 120 are described as a neural network for illustrative purposes only, and any other MLMs such as a recurrent network (RNN, GRU, LSTM, etc.) can be implemented in the MLM modules 120. For example, the cheating behavior of the user 107 can be predicted using a prepared recurrent network to recognize specific behavior events in the 3D video by at least tracking the user, the identified objects, and the detected events in a sequence of frames of the 3D video. As another non limiting example, a sequence-to-sequence transformer model can be trained with a sequence of events to predict the next sequence of events which will be used to generate warnings.

The 3D proctoring engine 102 may execute a list generation module 134 configured to generate a list of identified objects in the 3D video based on an output of the trained 3D object detection ML model and a list of detected events in the 3D video based on the detected events in the 3D video. The list of detected events includes at least events determined as suspicious cheating activity and events determined as normal test taking activity. In some aspects, the list generation module 134 may be further configured to perform various filtering and post-processing techniques to the list of identified objects and/or detected events to enhance accuracy, reduce noise, and provide actionable insights. For example, when identifying objects, class-specific filtering, spatial constraints, temporal filtering, and confidence thresholding can help focus on relevant objects and remove false positives. As another example, when detecting events, duration-based filtering, intensity threshold, context-aware analysis, and frequency filtering may ensure that only significant and persistent activities are flagged.

The 3D proctoring engine 102 may execute the list generation module 134 to enhance the analysis of 3D video data by organizing critical outputs of the trained MLM in the trained 3D object detection module 122. The list generation module 134 generates two key lists: one detailing the identified objects in the 3D video, such as test materials, unauthorized test materials, or user interactions, and another cataloging detected events. The event list classifies activities as either normal test-taking behavior or suspicious cheating activity, aiding in effective monitoring and evaluation. In some aspects, the list generation module 134 may also generate a list of events to detect, a list of cheating events, a list of allowed events and a list of prohibited events.

As an example, during test-taking, a list of allowed events may include actions such as asking test administrators for clarification on exam questions or instructions, requesting replacement materials like pens or extra sheets, and using approved tools like calculators or reference sheets when permitted. Users may also take restroom breaks or adjust their seating position quietly, provided these actions comply with the rules. On the other hand, prohibited events include using unauthorized materials (e.g., notes, phones, or smartwatches), attempting to copy another test-taker's answer, or engaging in any form of unauthorized communication, such as whispering, signaling, or texting. Other prohibited behaviors include tampering with exam materials, removing test content from the room without permission, impersonating another test-taker, and using disallowed devices or software. Additionally, disruptive behaviors like talking loudly or arguing with test administrators and unauthorized movement, such as leaving the room without permission, are strictly forbidden. These lists may vary depending on the type of exam (e.g., online vs. in-person or open-book vs. closed-book), making clear communication of rules essential to ensure compliance.

By leveraging advanced MLMs to analyze spatial and temporal patterns, the list generation module 134 provides a structured summary that facilitates quick review and targeted intervention in scenarios requiring closer scrutiny. Examples of spatial and temporal patterns in test-taking behavior include movements, actions, and trends that may indicate unusual or suspicious activity. Spatial patterns involve physical positioning and gestures, such as repeated head or eye movements toward another test-taker's desk, consistent fidgeting with specific areas of the desk or clothing or leaning excessively toward a neighbor. These also include seating arrangements that facilitate collaboration or clustered movements in shared spaces. Temporal patterns focus on time-based trends, such as multiple frequent break requests, sudden bursts of rapid typing or writing, long pauses followed by irregular activity, or repeated glances toward specific locations like hidden devices. Combined spatial-temporal patterns occur when these elements align, such as two test-takers exhibiting synchronized movements like leaning or whispering, or periodic gestures toward unauthorized materials that follow a noticeable timing pattern. By analyzing these spatial and temporal behaviors, the module can detect subtle trends that may indicate the need for further scrutiny or intervention.

The 3D proctoring engine 102 may execute an optional alert module 136 configured to display a warning in real-time based on the outputs of the prepared behavior prediction MLM from the optional behavior prediction module 128. The optional alert module 136 is configured to display warnings instantly when anomalous or predefined conditions are detected, such as potential rule violations or suspicious activities. By providing immediate feedback, the optional alert module 136 enables timely intervention and reduces the risk of oversight during critical processes. Its real-time capability ensures that users or administrators can address issues as they arise, enhancing the efficiency and reliability of automated online proctoring systems.

The 3D proctoring engine 102 may execute an optional VR conversion engine 138 configured to generate a VR feed for use on a VR-compatible headset. The optional VR conversion engine 138 is designed to process data and generate a VR feed that is compatible with VR headsets. The optional VR conversion engine 138 takes an input from various sources, such as the 3D generated video and/or video feeds and converts it into a format optimized for VR environments. The optional VR conversion engine 138 ensures the output is tailored for immersive experiences by applying transformations like stereoscopic rendering, spatial audio adjustments, and real-time interaction mapping. Once processed, the VR feed is transmitted to the VR-compatible headset, enabling a second user (e.g., proctor, teacher, etc.) to experience the content in a fully immersive virtual reality setting.

The 3D proctoring engine 102 may execute a display module 140. The display module 140 may be configured to generate and display the examination to the user 107. Generally, the display module 140 is responsible for managing and rendering the visual components of the user interface by handling the presentation of information to the user, ensuring that data and controls are displayed correctly and consistently across the UI.

In some aspects, the display module 140 is configured to render or draw all the elements of the UI, such as windows, buttons, text fields, menus, icons, images, and other components. In some aspects, the display module 140 is configured out update the UI when the data changes or user interactions occur (e.g., clicking a button or typing in a text box) such that the display module updates the UI accordingly. This could mean refreshing a portion of the screen, changing the state of a button, or displaying new data. In other words, the display module 140 may be considered the “view” part of a model-view-controller (MVC) or similar design pattern. It serves as the layer that presents data to the user and receives input to and from the device 105.

It should be noted that the generation of a 3D video from the multiple cameras, identification of objects in the 3D video, detection of events by identifying objects in the 3D video, and prediction of cheating behavior based on the event detection in the present disclosure are heavily simplified. One skilled in the art will appreciate that the embedding models utilized may have significantly large datasets with highly specific details. This type of analysis would be beyond the capabilities of the human mind because the amount of data to be identified, considered, and processed is unfathomable.

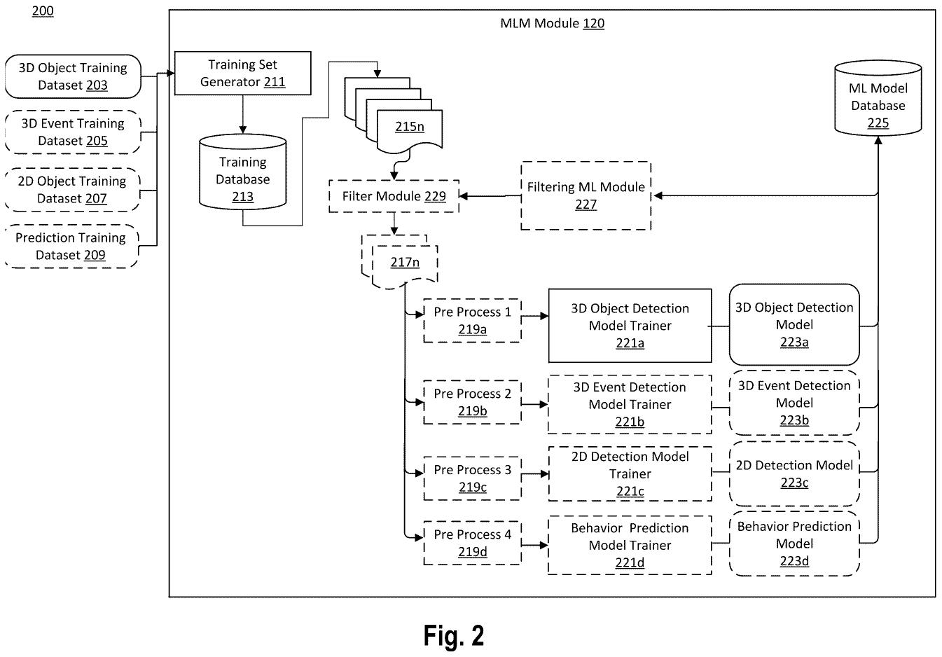

FIG. 2 is a block diagram illustrating a system for training machine learning models (MLMs) to identify objects, detect events, and/or predicting cheating behavior in a 3D video of a user taking an examination according to aspects of the present disclosure. As shown in example 200, the MLM module 120 is configured to build and train specialized MLMs to perform particular tasks. This enables the specialized MLMs to develop an ability to perform particular objectives within new images and videos that are not part of the training dataset. By subjecting the specialized MLMs to large amounts of labeled and/or unlabeled trained image data sets, the specialized MLMs may perform particular tasks such as identifying objects that a user (e.g., the user 107 shown in FIG. 1) interacts with while taking an examination, detecting the objects in a 3D video, detecting events in the 3D video based on the detected objects, perform validation on the identified objects and detected events, and/or predicting cheating behavior of the user.

Supervised learning is effective for tasks such as classification (assigning inputs to predefined categories) and regression (predicting continuous values) since it relies on the availability of labeled data for both training and evaluation phases. In supervised learning, the MLM module 120 trains the algorithm on a labeled dataset, where each input has a corresponding output. The goal is to learn a mapping function from inputs to outputs, allowing the algorithm to make predictions or classifications on new, unseen data. The process typically involves the following steps: model building, training, prediction, feedback, and adjustment. In the training phase, the MLM module 120 provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, the MLM module 120 inputs test inputs (i.e., inputs with known outputs) into the model, which generates predictions or classifications based on what it has learned during training. The accuracy of predictions is evaluated by comparing them to the known outputs in a validation or test dataset. During the training, the algorithm refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the MLM module 120 contains at least a training database 213 (e.g., training database 130 shown in FIG. 1) configured to store the raw training data 215n and corresponding labels, a MLM database 225 to store the trained models (e.g., a 3D object detection model 223 a, an optional 3D event detection model 223b, an optional 2D detection model 223c, and/or an optional behavior prediction model 223d). In some aspects, the MLM module 120 may contain an optional filtering machine learning module 227 and an optional filter module 229 configured to filter data from the training database 213 for training by removing bad training data and/or images.

Training data from the 3D object training dataset 203, the optional 3D event training dataset 205, the optional 2D object training dataset 207, and/or the optional prediction training dataset 209 is received in the MLM module 120 via the training set generator 211. In some aspects, the 3D object training dataset 203 includes images of objects and an object label identifying each object in the images to visually detect and distinguish between different objects. In some aspects, the optional 3D event training dataset 205 includes sequence of frames containing an object or an action performed by the user and an event label identifying the action in the sequence of frames of a video. In some aspects, the optional 2D object training dataset 207 includes images of objects and an object label identifying each object in the images and an image of an action performed by the user and an event label identifying the action in the sequence of frames of a video. In some aspects, the optional prediction training dataset 209 includes a sequence of frames containing an action performed by a person with an object and an event label identifying the action in the sequence of frames of the video as cheating behavior, suspicious behavior, or normal test taking behavior.

An optional filter module 229 is configured to filter out bad training images and/or data in order to clean up the training data in the training dataset 215n. In some examples, the optional filter module 229 may be a neural network. In some examples, the optional filter module 229 is a simple mathematical model. In some examples, the cleaned training dataset 217n then undergoes optional preprocessing steps depending on which neural network or model is being trained.

The optional preprocess 1 219a, preprocess 2 219b, preprocess 3219c, and preprocess 219d are automated processes that modify the raw data received from 215n (or cleaned training dataset 217n) and prepare the raw data as input to the respective model trainers (e.g., a 3D object detection model trainer 221a, an optional 3D event detection model trainer 221b, an optional 3D detection model trainer 221c, and/or an optional behavior prediction model trainer 221d). These may be described in the MLM module 120 as snippets of code that prepares the datasets. In some examples, the preprocessing module (e.g., preprocess 1 219a, preprocess 2 219b, preprocess 3 219c, and preprocess 219d) for a particular trainer may be an automated script or code that will be setup the first time any model is trained.

The 3D object detection model trainer 221 a, optional 3D event detection model trainer 221b, optional 3D detection model trainer 221c, and/or optional behavior prediction model trainer 221d are the scripts or code that train the respective models. The 3D object detection model trainer 221a, optional 3D event detection model trainer 221b, optional 3D detection model trainer 221c, and/or optional behavior prediction model trainer 221d may be a script or code that holds the instructions on how a model should be trained (e.g., optimization method, model architecture, etc.) and also runs the training. The 3D object detection model trainer 221 a, optional 3D event detection model trainer 221b, optional 3D detection model trainer 221c, and/or optional behavior prediction model trainer 221d each take as input the raw or filtered processed training data and train the 3D object detection model 223a, the optional 3D event detection model 223b, the optional 2D detection model 223c, and/or the optional behavior prediction model 223d to achieve their specific objectives, respectively.

In summary, the raw dataset 215n or cleaned dataset 217n may optionally go through different optional preprocessing steps 219a, 219b, 219 c, and/or 219d and then a corresponding 3D object detection model trainer 221a, optional 3D event detection model trainer 221b, optional 3D detection model trainer 221c, and/or optional behavior prediction model trainer 221 d to generate a prepared 3D object detection model 223 a, a prepared optional 3D event detection model 223, a prepared optional 2D detection model 223c, and/or a prepared optional behavior prediction model 223d. In some examples, each of these models may be a neural network.

As a non-limiting example, the machine learning model may be a neural network. The neural network models are designed using a set of hyperparameters that define high-level aspects of their architecture and training process. These hyperparameters include but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 215n used for training may contain noise and bad training images from the training database 213. Accordingly, to create a clean and filtered training dataset, the optional filter module 229 is configured to filter out unwanted data points from the raw training dataset 215n by developing smaller, more accurate systems based on patterns and metadata information.

During the training process, the 3D object detection model trainer 221a, optional 3D event detection model trainer 221b, optional 3D detection model trainer 221c, and/or optional behavior prediction model trainer 221d (e.g., neural networks) are presented with images and labels, and the optimization objective, which aims to minimize the difference between the actual value and the predicted value, is calculated. The optimization algorithm updates the parameters of the 3D object detection model trainer 221a, optional 3D event detection model trainer 221b, optional 3D detection model trainer 221c, and/or optional behavior prediction model trainer 221d to reduce the value of the loss. This process is repeated for several iterations until the parameters do not change anymore. This process is repeated for various combinations of hyperparameters, and the model with the smallest label prediction error is selected as the final model.

When a new model (e.g., a prepared 3D object detection model 223a, a prepared optional 3D event detection model 223b, a prepared optional 2D detection model 223c, and a prepared optional behavior prediction model 223d) is created, and a new process for filtering and automated labeling is established, it is added to the MLM database 225 in the MLM module 120. This enables the new model to be part of the closed-loop model update process. Optionally, at regular intervals, data which is continuously collected can be filtered, labeled, and used to update old models by an optional filtering machine learning module 227. In some examples, the filtering machine learning module 227 is a neural network. In some examples, the filtering machine learning module 227 is a simple mathematical model. This approach may capture changes in the appearance of objects over time. However, if the visual appearances of the objects remain consistent, the existing large-scale data should be sufficient, and new data may not bring significant additional information.

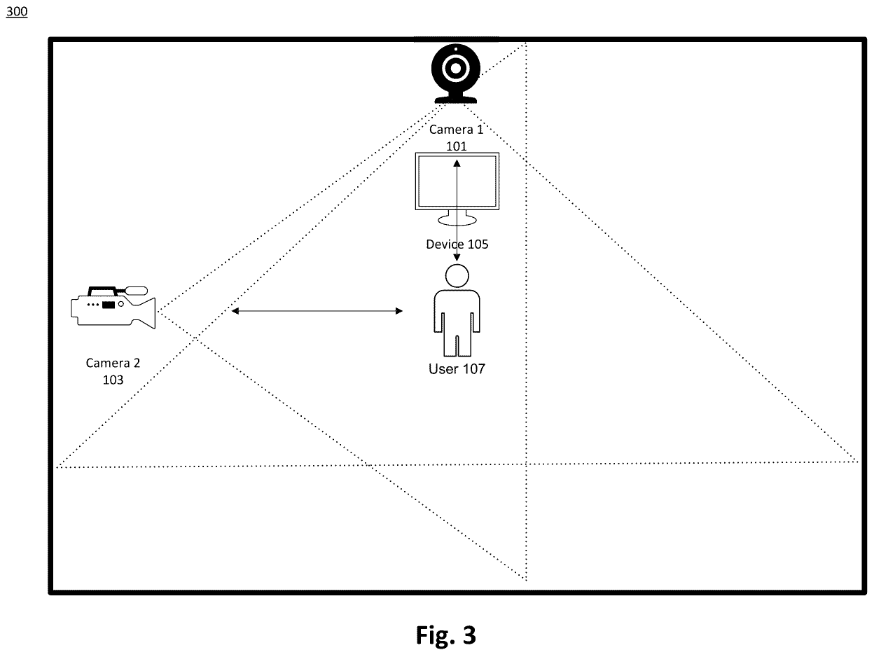

FIG. 3 is a block diagram illustrating an example system of multiple camera setups configured to generate a 3D proctoring video according to aspects of the present disclosure.

As shown in example 300 of FIG. 3, at least a first camera 101 and a second camera 103 are configured to capture video feeds of the user 107 taking an examination from different views and angles. Specifically, the first camera 101 may obtain a first video feed of the user 107 from a first angle and the second camera 103 may obtain a second video feed of the user from a second angle. In some aspects, the first camera may be a frontal camera that captures a frontal view feed of the user 107 and the second camera may be a side view camera that captures a side view feed of the user 107.

Generating a multi-view video from at least the first camera 101 and the second camera 103 capturing video feeds at different angles involves synchronizing and integrating the video feeds to create a cohesive output showcasing multiple perspectives. The process begins with camera setup and calibration, addressing intrinsic parameters (e.g., lens distortion, focal length) and extrinsic parameters (e.g., relative positions and orientations) to ensure spatial alignment. Synchronization ensures each frame corresponds to the same moment, achieved through hardware synchronization or timestamping. Feature detection algorithms like SIFT or ORB identify common elements in the scene to align frames spatially based on calibration data.

The multi-view video can be rendered in various styles: split-screen displays both angles simultaneously, alternating views switch perspectives dynamically, blended views combine feeds into a composite image, or interactive formats allow users to toggle angles during playback. Post-processing enhances the video with color correction, motion stabilization, and audio synchronization for consistency. Finally, the video is exported in a suitable format for playback, offering a coherent, multi-perspective representation of the captured scene.

Although example 300 shows the first camera 101 capturing a frontal video feed of the user 107 and the second camera 103 capturing a side video feed of the user 107, it should be noted that the cameras may capture any two different views of the user.

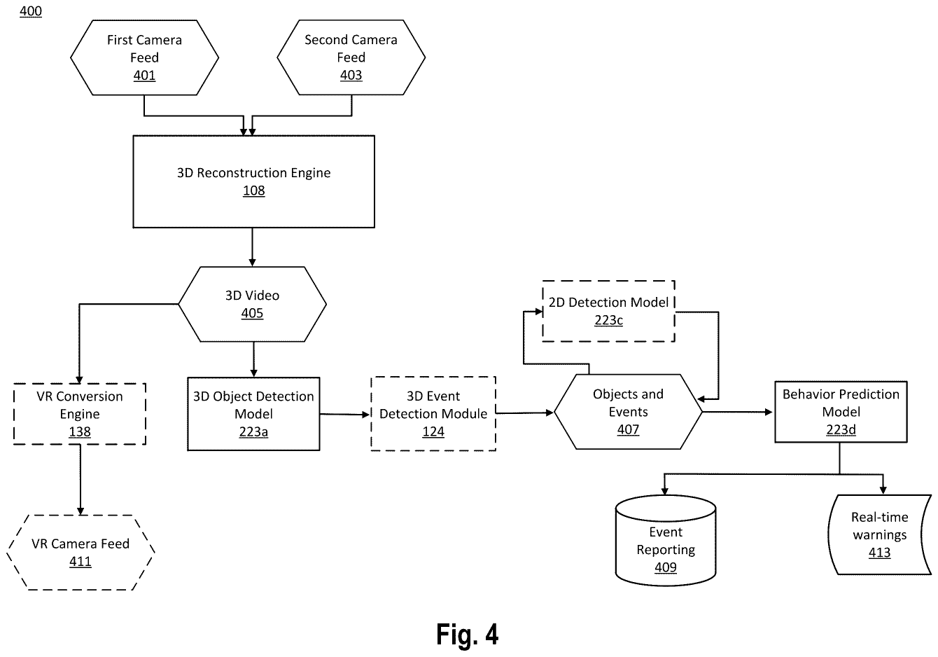

FIG. 4 is a block diagram of an example of a pipeline for reconstructing a 3D video to detect suspicious behavior of a user taking an examination according to an aspect of the present disclosure.

As shown in the system 400 of FIG. 4, a first camera feed 401 from a first camera (e.g., first camera 101 shown in FIGS. 1 and 3) and a second camera feed 403 from a second camera (e.g., second camera 103 shown in FIGS. 1 and 3) is input into a 3D reconstruction engine 108 to generate a 3D video 405. This process utilizes the differing perspectives captured by the two cameras (e.g., the first camera and the second camera) to reconstruct depth and spatial information, producing a three-dimensional representation of the scene of the user taking the examination. The significance of this lies in its ability to create an immersive and realistic 3D visualization from standard camera feeds, which can be used in applications such as virtual reality, augmented reality, and advanced content creation. By transforming 2D video feeds into 3D models, it enables deeper interaction and analysis of the captured scene of the user taking the examination.

The 3D video 405 is then input into a 3D object detection model 223a to identify objects that the user interacts with while taking the examination. This process leverages the spatial and depth data from the 3D video 405 to accurately detect and analyze objects in the user's test taking environment, as well as their interactions with them. The significance lies in its ability to enhance the integrity and fairness of online exams by providing robust monitoring that detects unauthorized materials or suspicious behavior. This advanced detection ensures a more secure testing environment, addressing challenges of academic dishonesty while maintaining user privacy and fairness.

In some aspects, the 3D video 405 is also input into an optional 3D event detection module 124 to detect specific events involving the identified object in the 3D video 405 feed during an examination. The optional 3D event detection module 124 enhances the integrity of the examination process by detecting potential anomalies or unauthorized activities in real-time. By leveraging 3D event detection, the system 400 provides a robust mechanism to monitor the test-taking environment, ensuring compliance with examination protocols and mitigating risks of malpractice, thereby reinforcing the reliability and fairness of the assessment process.

In some aspects, objects and events may be detected in the 2D video feeds from the first camera feed 401 and/or the second camera feed 403. The advantage of this process may be less noise and higher resolution than a generated 3D video.

In some aspects, objects and events may be detected in the 3D video and detected in the 2D video feeds from the first camera feed 401 and/or the second camera feed 403 in parallel processing or alternate processing. In the alternate processing method, the main pipeline may be first attempting to detect the objects and events in the 3D video and based on the detection of the objects and events, verifying the objects and events by using the first camera feed 401 and/or the second camera feed 403. In some aspects, the order of validation (e.g., 2D to 3D or 3D to 2D) will depend on which detector is more generic and which is faster. For example, the faster and more generic detector usually comes first to filter out common detections before moving the surviving events to the more expensive, but mor precise detector.

In some aspects, the identified objects and detected events 407 undergo a validation process using an optional 2D detection model 223c to ensure their accuracy and relevance. This step acts as a safeguard by filtering out false positives or inaccuracies that may arise during the initial detection. By discarding objects or events 407 that fail the validation process, the system 400 maintains a higher standard of reliability and precision in its outputs. This validation is critical in contexts such as examination monitoring, where accurate detection of activities or anomalies directly impacts the integrity and fairness of the process. In some aspects, the system may be configured to accept an event as recognized only if it is recognized by both channels (e.g., 3D and 2D), any one of the channels, or a specific channel. In some aspects, the system can display a level of confidence corresponding to the object and/or event detection. In this way, if an object and/or event is detected by both methods, then this represents the highest level of confidence. Accordingly, if it is detected by only one method, the system can display the information with a lower level of confidence. In some aspects, the confidence may be displayed by outputting a score or indicated using different colors.

The identified objects and detected events 407 are analyzed using an optional behavior prediction model 223d to assess the likelihood of cheating behavior by the user based on the detected events. This model leverages patterns and contextual data to make real-time predictions about suspicious activities. When suspicious behavior is detected, the system 400 can trigger a real-time warning 413, alerting the user or proctors to address the issue promptly. This predictive capability is significant for maintaining the integrity of examinations by providing proactive measures to deter and mitigate dishonest behaviors, ensuring a fair and secure assessment environment.

In addition, the suspicious events are stored in an event reporting database 409, creating a comprehensive record of all detected anomalies during the examination. This storage capability allows for post-examination review and analysis, enabling administrators to assess the context and validity of flagged events. By maintaining an auditable log, the system 400 supports transparency, accountability, and the ability to resolve disputes or verify the integrity of the examination process. This feature ensures that decisions regarding potential misconduct are informed by detailed and accurate historical data.

In some aspects, the 3D video 405 is input into the optional VR conversion engine 138 to generate a VR camera feed 411, enabling compatibility with VR-compatible headsets. This transformation involves adapting the 3D video into a format that supports immersive viewing, such as stereoscopic rendering, spatial audio integration, and interactive capabilities. The significance lies in its ability to translate a pre-recorded 3D video into a fully immersive VR experience, allowing users to explore the content in a dynamic, spatially aware environment. This enhances engagement and provides applications across entertainment, education, and training by leveraging the immersive potential of VR technology.

In some aspects, proctors or administrators may re-watch the examination in case of a debated suspicion of cheating events or for further reference.

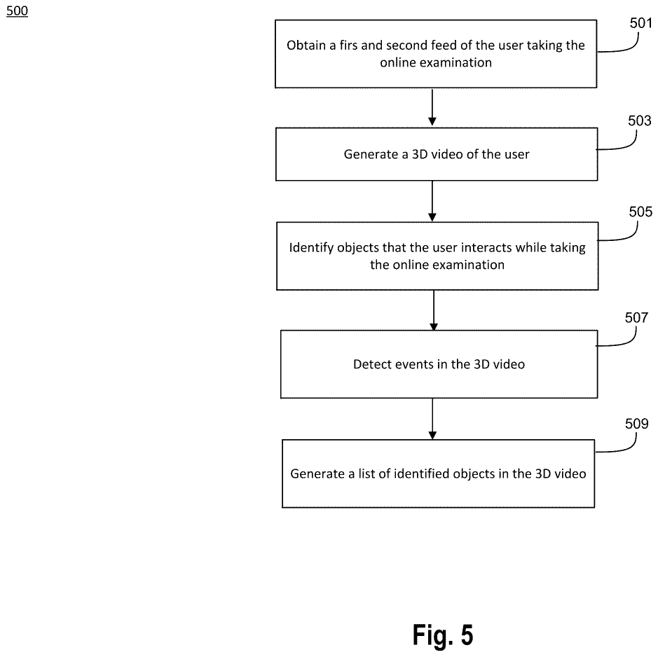

FIG. 5 is an example method for generating a 3D proctor video of a user taking an examination according to aspects of the present disclosure. In various implementations, the method 500 is performed by a device with one or more processors and non-transitory memory that performs intent prediction. In some implementations, the method 500 is performed by processing logic, including hardware, firmware, software, or a combination thereof. In some implementations, the method 500 is performed by a processor executing code stored in a non-transitory computer-readable medium (e.g., a memory). The method 500 describes a method detecting suspicious cheating activity and normal test taking activity when a user is taking an examination based on a 3D generated video.

At 501, the method 500 includes obtaining, from a first camera and a second camera pointed at the user, a first and a second video feed of the user taking the examination, respectively. In some aspects, the first video feed includes a frontal view feed and the second video feed includes a side view feed.

At 503, the method 500 includes generating a 3D video of the user by inputting the first and second video feeds into a 3D reconstruction engine.

At 505, the method 500 includes identifying objects that the user interacts with while taking the examination by using a trained 3D object detection MLM. For example, the method 500 may include identifying a user's head and how it is oriented.

Optionally, the method 500 includes training the 3D object detection ML model to detect objects in the 3D video using a training 3D object dataset comprising images of objects and an object label identifying each object in the images to visually detect and distinguish between different objects. In some aspects, the 3D object detection model may correspond to an existing MLM such as YOLO3D or ModelNet40 to detect events and objects in the 3D video.

At 507, the method 500 includes detecting events in the 3D video based on the identified objects. Following on the above example, the method 500 may include detecting an event that the user is looking away based on identifying the user's head.

Optionally, the method 500 includes training a 3D event detection ML model to detect events in the 3D video using a training 3D events dataset comprising a sequence of frames containing an action performed by the user and an event label identifying the action in the sequence of frames of a video; and detecting events in the 3D video by using the trained 3D event detection ML model.

Optionally, the method 500 includes after detecting the events in the 3D video analytically or using a machine learning model. For example, after having detected 3D objects, an event can be determined analytically (e.g., rule-based) or even with another trainable MLM (SVM, NN, or the like).

At 509, the method 500 includes generating a list of identified objects in the 3D video based on an output of the trained 3D object detection ML model and a list of detected events in the 3D video based on the detected events in the 3D video. The list of detected events may include events determined as suspicious cheating activity and events determined as normal test taking activity.

In some aspects, the list of events to detect comprises a list of cheating events, a list of allowed events corresponding to normal test taking behavior, and a list of prohibited events corresponding to suspicious activities.

Optionally, the method 500 includes performing a validation on the identified objects and detected events in the 3D video by utilizing a trained 2D detection model trained with 2D images by identifying objects in a first 2D video feed and detecting events in a second 2D video feed; and discarding identified objects or detected events that do not pass the validation from the generated list.

Optionally, the method 500 includes performing a validation on the identified objects and detected events in the 3D video by utilizing a trained 2D detection model trained with images obtained from a stitching of the multi-view video feeds from the first and second cameras-; and discarding identified objects or detected events that do not pass the validation from the generated list.

Optionally, the method 500 includes training the 2D detection model to detect objects in 2D images using a 2D object dataset comprising images of objects and an object identifying each object in the images to visually detect and distinguish between different objects.

Optionally, the method 500 includes predicting cheating behavior of the user based on inputting the generated list of events or objects detected in the 3D video into a trained recurrent network to recognize specific behavior events in the 3D video by at least tracking the user, the identified objects, and the detected events in a sequence of frames of the 3D video. In some examples, the recurrent network may correspond to a RNN, GRU, or LTSM.

Optionally, the method 500 includes displaying, on a computer of the user, a warning in real-time based on the outputs of the prepared behavior prediction model.

Optionally, the method 500 includes training the prediction model to predict cheating behavior of the user by using a prediction training set comprising of a sequence of frames containing an action performed by a person with an object and an event label identifying the action in the sequence of frames of the video as cheating behavior, suspicious behavior, or normal test taking behavior to visually detect and distinguish between cheating behavior and normal test taking behavior. In some aspects, the prediction model corresponds to a sequential mode, recurrent model, or sequence-to-sequence transformer model.

Optionally, the method 500 includes generating a virtual-reality (VR) feed for use on a VR-compatible headset using a VR conversion engine. In some aspects, the VR feed may correspond to VR video file formats such as side-by-side (SBS), over-under (OU), or the like. In some aspects, FFmpeg may be used for conversions. FFmpeg is a powerful, open-source multimedia framework used for processing audio, video, and other multimedia files and streams. FFmpeg provides a suite of tools and libraries for encoding, decoding, transcoding, muxing, demuxing, streaming, filtering, and playing media files.

FIG. 6 is a block diagram illustrating a computer system 20 on which aspects of systems and methods for generating a 3D proctor video of a user taking an examination according to aspects of the present disclosure. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for generating a three-dimensional (3D) proctor video of a user taking an examination, comprising:
obtaining, from a first camera and a second camera pointed at the user, a first and a second video feed of the user taking the examination, respectively;
generating a 3D video of the user by inputting the first and the second video feed into a 3D reconstruction engine;
identifying objects that the user interacts with while taking the examination by using a prepared 3D object detection machine learning model (MLM);
detecting events in the 3D video based on the identified objects; and
generating a list of identified objects in the 3D video based on an output of the prepared 3D object detection MLM and a list of detected events in the 3D video based on the detected events in the 3D video, wherein the list of detected events comprises at least events determined as suspicious cheating activity and events determined as normal test taking activity.

2. The method of claim 1, wherein the list of events to detect further comprises at least events determined as normal test taking activity.

3. The method of claim 1, further comprising:
training a 3D event detection ML model to detect events in the 3D video using a training 3D events dataset comprising a sequence of frames containing an object or an action performed by the user and an event label identifying the action in the sequence of frames of a video; and
detecting events in the 3D video by using the trained 3D event detection ML model.

4. The method of claim 1, further comprising:
performing a validation on the identified objects and detected events in the 3D video by utilizing a trained 2D detection model trained with 2D images by identifying objects in a first 2D video feed and detecting events in a second 2D video feed; and
discarding identified objects or detected events that do not pass the validation from the generated list.

5. The method of claim 1, further comprising:
performing a validation on the identified objects and detected events in the 3D video by utilizing a trained 2D detection model trained with 2D images obtained from a stitching of the video feed from the first camera and the video feed of the second camera; and
discarding identified objects or detected events that do not pass the validation from the generated list.

6. The method of claim 5, further comprising:
training the 2D detection model to detect objects in 2D images using a 2D object dataset comprising images of objects and an object label identifying each object in the images to visually detect and distinguish between different objects.

7. The method of claim 1, further comprising:
predicting cheating behavior of the user based on inputting the generated list of events or objects detected in the 3D video into a trained behavior prediction model to recognize specific behavior events in the 3D video by at least tracking the user, the identified objects, and the detected events in a sequence of frames of the 3D video.

8. The method of claim 7, wherein the trained behavior prediction model corresponds to sequential models such as a recurrent neural network (RNN)or a Transformer model.

9. The method of claim 7, further comprising:
displaying, on a computer of the user, a warning in real-time based on the outputs of the trained behavior prediction model.

10. The method of claim 9, further comprising:
training the behavior prediction model to predict cheating behavior of the user by using a prediction training set comprising of a sequence of frames containing an object or an action performed by a person with an object and an event label identifying the action in the sequence of frames of the video as cheating behavior, suspicious behavior, or normal test taking behavior to visually detect and distinguish between the cheating behavior, suspicious behavior, or normal test taking behavior.

11. The method of claim 1, wherein the 3D video events are detected analytically.

12. The method of claim 1, further comprising:
generating a virtual-reality (VR) feed for use on a VR-compatible headset using a VR conversion engine.

13. The method of claim 1, wherein the multi-view video feed comprises at least a frontal view feed and a side view feed of the user.

14. The method of claim 1, wherein the list of events to detect further comprises at least a list of cheating events, a list of allowed events corresponding to normal test taking behavior, and a list of prohibited test taking behavior.

15. A system for generating a 3D proctor video of a user taking an examination, comprising:
at least one memory;
at least one hardware processor coupled with the at least one memory and configured, individually or in combination, to:
obtain, from a first camera and a second camera pointed at the user, a first and a second multi-view video feed of the user taking the examination, respectively;
generate a 3D video of the user by inputting the first and the second multi-view video feed into a 3D reconstruction engine;
identify objects that the user interacts with while taking the examination by using a prepared 3D object detection machine learning model (MLM);
detect events in the 3D video based on the identified object; and
generate a list of identified objects in the 3D video based on an output of the prepared 3D object detection MLM and a list of detected events in the 3D video based on the detected events in the 3D video, wherein the list of detected events comprises at least events determined as suspicious cheating activity and events determined as normal test taking activity.

16. The system of claim 15, wherein the list of events to detect further comprises at least events determined as normal test taking activity.

17. The system of claim 15, wherein the at least one hardware processor is further coupled with the at least one memory and configured, individually or in combination, to:
train a 3D event detection ML model to detect events in the 3D video using a training 3D events dataset comprising a sequence of frames containing an object or an action performed by the user and an event label identifying the action in the sequence of frames of a video; and
detect events in the 3D video by using the trained 3D event detection ML model.

18. The system of claim 15, wherein the at least one hardware processor is further coupled with the at least one memory and configured, individually or in combination, to:
perform a validation on the identified objects and detected events in the 3D video by utilizing a trained 2D detection model trained with 2D images by identifying objects in a first 2D video feed and detecting events in a second 2D video feed; and
discard identified objects or detected events that do not pass the validation from the generated list.

19. The system of claim 15, wherein the at least one hardware processor is further coupled with the at least one memory and configured, individually or in combination, to:
perform a validation on the identified objects and detected events in the 3D video by utilizing a trained 2D detection model trained with images obtained from a stitching of the multi-view video feed from the first camera and the multi-view video feed of the second camera; and
discard identified objects or detected events that do not pass the validation from the generated list.

20. A non-transitory computer readable medium storing thereon computer executable instructions for generating a 3D proctor video of a user taking an examination, including instructions for:
obtaining, from a first camera and a second camera pointed at the user, a first and a second multi-view video feed of the user taking the examination, respectively;
generating a 3D video of the user by inputting the first and the second multi-view video feed into a 3D reconstruction engine;
identifying objects that the user interacts with while taking the examination by using a prepared 3D object detection machine learning model (MLM);
detecting events in the 3D video based on the identified objects; and
generating a list of identified objects in the 3D video based on an output of the prepared 3D object detection MLM and a list of detected events in the 3D video based on the detected events in the 3D video, wherein the list of detected events comprises at least events determined as suspicious cheating activity and events determined as normal test taking activity.
